(19) United States
(12) Patent Application Publication
(10) Pub. No.: US 2018/0033218 A1
(43) Pub. Date: Feb. 1, 2018

(54) REMOTELY CONNECTED CAR INTERNET OF THINGS KEY

(71) Applicant: Panasonic Automotive Systems Company of America, Division of Panasonic Corporation of North America, Peachtree City, GA (US)

(72) Inventor: ABHISHEK SONI, SUNNYVALE, CA (US)

(21) Appl. No.: 15/655,425

(22) Filed: Jul. 20, 2017

Related U.S. Application Data
(60) Provisional application No. 62/368,660, filed on Jul. 29, 2016.

(51) Int. Cl. G07C 5/00; H04W 12/06; H04L 29/06; G07C 5/08; G08B 5/22

(52) U.S. Cl. CPC G07C 5/008; G07C 5/0816; G08B 5/224; H04L 63/083; H04W 12/06

(57) ABSTRACT

A motor vehicle remote monitoring arrangement includes a motor vehicle having a wireless communication device transmitting a vehicle status signal. A vehicle key receives the vehicle status signal via a mobile electronic device and provides an indication to a user of the vehicle. The indication is indicative of the vehicle status

### CROSS-REFERENCED TO RELATED APPLICATIONS

This application claims benefit of U.S. Provisional Application No. 62/368,660 filed on Jul. 29, 2016, which the disclosure of which is hereby incorporated by reference in its entirety for all purposes.

### FIELD OF THE INVENTION

The disclosure relates to a monitoring system for a motor vehicle.

### BACKGROUND OF THE INVENTION

When a car owner is away from his parked car, he is often unaware of the current environment in which the car is parked and he does not have a way to get firsthand information of any event in which his car is involved while he is not present. For example, the car owner who is away from his car has no find to be informed if his car is broken into or damaged in a parking lot, or if the fuel level is very low for next drive.

Currently, an alarm in the car may be activated if the car is involved in any accident while parked. It is also possible to access the health of the car on a website or on a car mobile application via the internet. However, there is no way to have the car, the car owner's mobile phone and the car key interconnected in a three-way gateway to enable the car owner to access information about the car. The car key does not have the capability to show the owner the state of car via indicators as there is no way to connect the key to the car via the cloud or internet.

### SUMMARY

The present invention may remotely provide the car owner with information on demand about the state of his ear via an indicator on his car key or on his mobile phone. The car key may be connected to the car remotely through a user-owned unique personal electronic device such as a mobile phone, tablet, smart watch or any computing device with internet and personal area network (PAN) communication ability such as Bluetooth (BT), Bluetooth low energy (BTLE), Wi-Fi, etc. The personal electronic device or computing device may be connected to the car via the interact cloud or any other wired or wireless methods and may act as a gateway to the car key to enable the car owner to determine the status of his car. For example, the car owner may be informed via indicators on his car key that the fuel level is low, that the theft alarm has been activated, or that the car has been hit by another vehicle when the car owner is not present.

The invention may employ low power BT- or PAN-based wireless communication between a wireless communication device, such as a mobile electronic device, tablet, smart watch or any computing device with internet and PAN communication ability, and a car key to enable the car key the access information related to the diagnostic health status of the car. The user can get instant car health information by looking at indicators on the car key.

In the prior art, in order to send commands from the car key to the car, to remotely start the car, for example, the user has to be disposed within the range of the wireless communication in order for the signal to reach the car. But with this invention, the user can start a car by pressing on the ignition button from anywhere as the signal is sent from the car key to an authenticated device such as a mobile phone, tablet, smart watch, personal computer, computing device, etc., and then to the car via the internet

Before entering the car to begin a trip, the user picks up his car keys but there is no way he can get an on-demand status of his car health, such as an indication of low fuel. Thus, the user does not know whether he needs to leave earlier in order to get fuel. With this invention, however, the user can look at the low fuel indicator on his car key and make a decision to leave earlier in order to get fuel.

In one embodiment, the invention comprises a motor vehicle remote monitoring arrangement including a motor vehicle having a wireless communication device transmitting a vehicle status signal. A vehicle key receives the vehicle status signal via a mobile electronic device and provides a visible indication to a user of the vehicle. The indication is indicative of the vehicle status signal.

In another embodiment, the invention comprises a method of remotely monitoring a motor vehicle, including transmitting a vehicle status signal from the motor vehicle. The vehicle status signal is received at the vehicle key. The vehicle status signal is received via a mobile electronic device. A visual indication on the vehicle key is provided to a user of the vehicle. The indication is indicative of the vehicle status signal.

In yet another embodiment, the invention comprises a method of remotely monitoring a motor vehicle, including responding to a user pressing a pushbutton on a key fob by transmitting a wireless vehicle status request signal. The wireless vehicle status request signal is received at the motor vehicle. The wireless vehicle status request signal is received via a mobile electronic device. Receipt of the wireless vehicle status request signal is responded to by transmitting a wireless vehicle status signal from the motor vehicle. The vehicle status signal is received at the key fob via the mobile electronic device. An indication of the vehicle status signal is provided by the key fob to a user of the vehicle.

### BRIEF DESCRIPTION OF THE DRAWINGS

A better understanding of the present invention will be had upon reference to the following description in conjunction with the accompanying drawings,

FIG. 1 is a block diagram of one example embodiment of a vehicle monitoring arrangement of the present invention.

FIG. 2 is a schematic diagram of the vehicle monitoring arrangement of FIG. 1,

FIG. 3 is another schematic diagram of the vehicle monitoring arrangement of FIG. 1.

FIG. 4 is a diagram of the flow relationship between FIGS. 4A and 4B.

FIG. 4A is a flow chart of a first portion of one embodiment of a vehicle monitoring method of the present invention.

FIG. 4B is a flow chart of a second portion of the vehicle monitoring method that is partially presented in FIG. 4A.

FIG. 5 is a flow chart of one embodiment of a method of the present invention for remotely monitoring a motor vehicle.

### DETAILED DESCRIPTION OF THE PREFERRED EMBODIMENTS

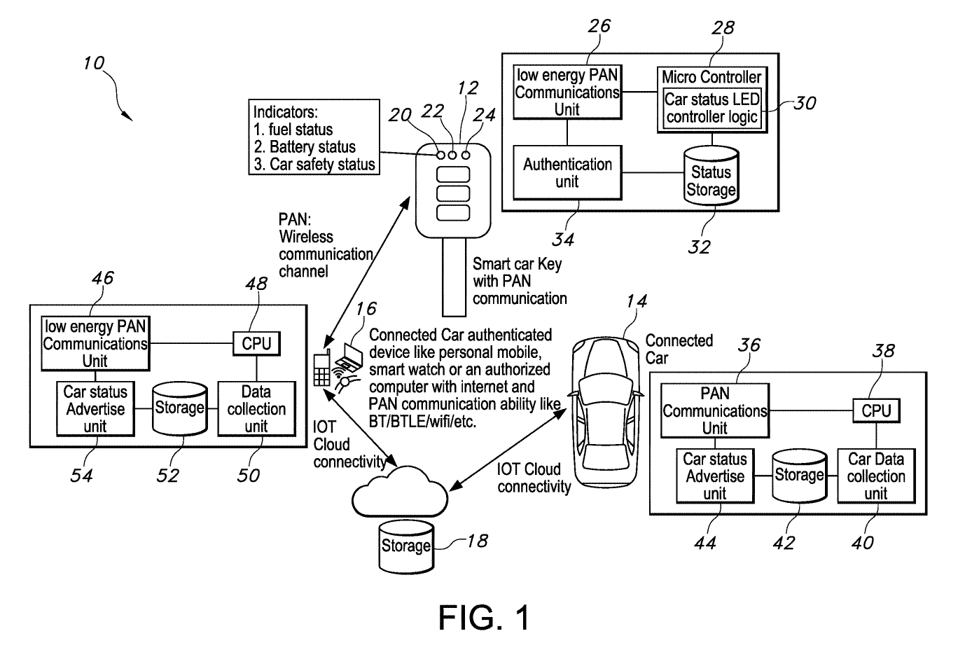

FIG. 1 illustrates a vehicle monitoring arrangement 10 of the present invention, including a smart car key or key fob 12 with PAN communication, a wirelessly connected vehicle 14, a connected car authenticated electronic device 16, and a cloud storage device 18. Smart car key 12 includes three LED indicators, namely, a low fuel level indicator 20, a low battery indicator 22, and a car safety status indicator 24. Smart car key 12 includes a low energy PAN communications unit 26, a micro controller 28 with car status LED controller logic 30, status storage 32 and an authentication unit 34.

Vehicle 14 includes a PAN communications unit 36, a computer processing unit (CPU) 38, a car data collection unit 40, a storage device 42 and a car status advertise unit 44. Vehicle 14 is connected to cloud storage device 18 via internet of things (IOT) cloud connectivity. Cloud storage device 18, in turn, is connected to electronic device 16 via IOT cloud connectivity.

Electronic device 16 may be a personal mobile device, a smart watch, or an authorized computer with internet and PAN communication ability such as BT, BTLE, Wi-Fi, etc. Electronic device 16 includes a low energy PAN communications unit 46, a computer processing unit (CPU) 48, a data collection unit 50, a storage device 52 and a car status advertise unit 54. Electronic device 16 is communicatively coupled to smart car key 12 via a PAN wireless communication Channel.

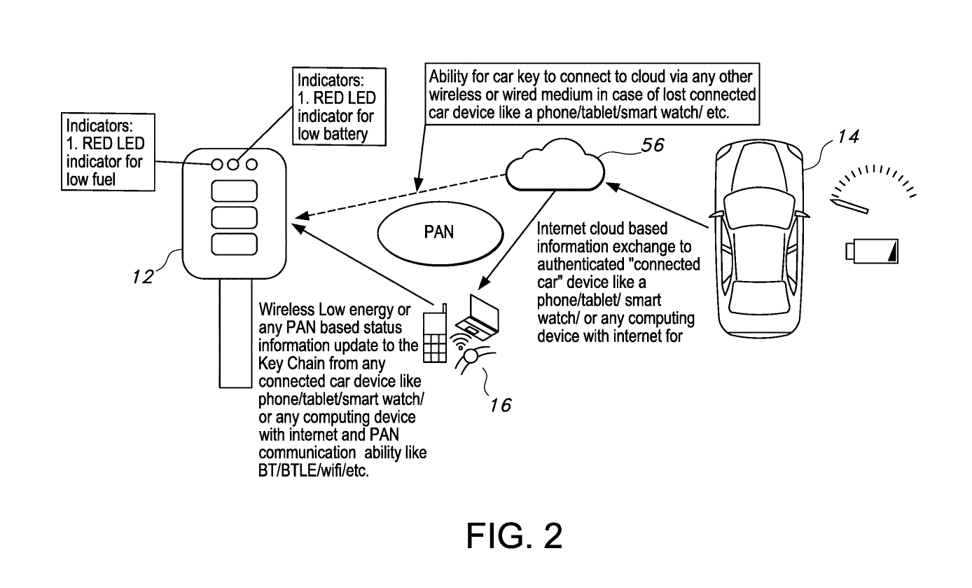

As shown in FIG. 2, the invention provides the ability for car key 12 to connect to cloud 56 via any other wireless or wired medium in case of a lost connected car device, such as a mobile telephone, tablet computer, smart watch, etc. Car 14 has an interne cloud based information exchange to authenticated “connected car” device such as a mobile telephone, tablet, smart watch, etc. or any computing device with interact connectivity. Electronic device 16 may communicate via wireless low energy or any PAN based status information update to car key 12.

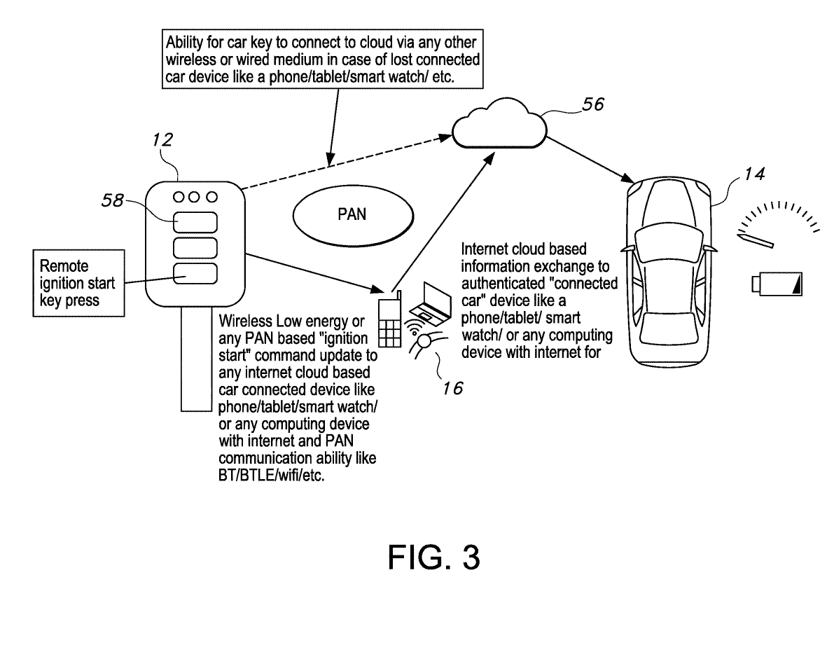

As shown in FIG. 3, car key 12 may communicate via wireless low energy or any PAN based ignition start command update to electronic device 16.

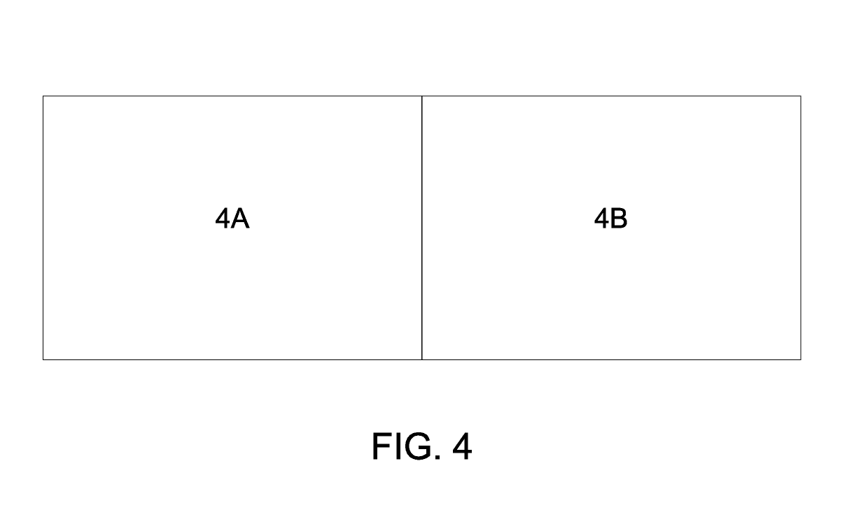

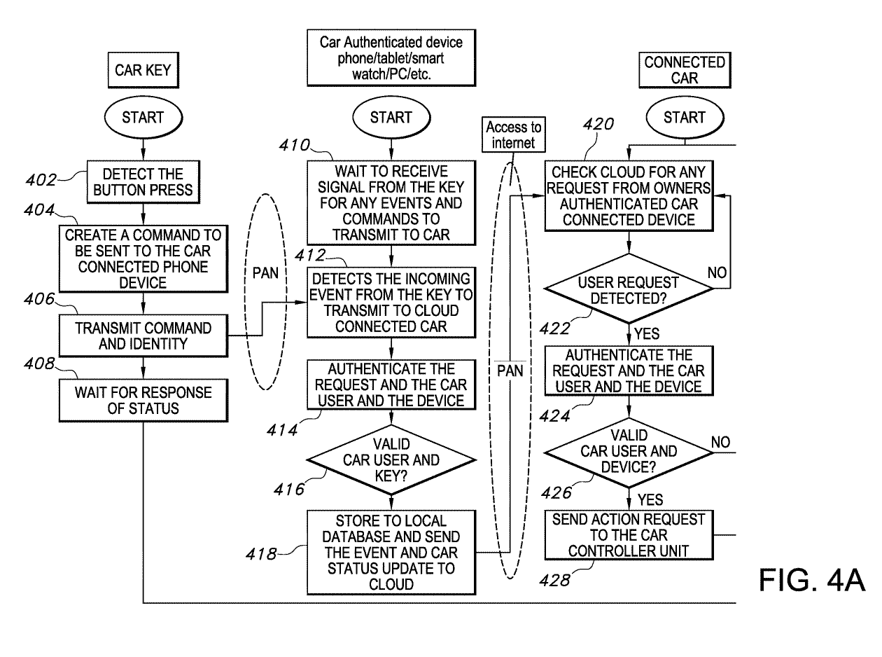

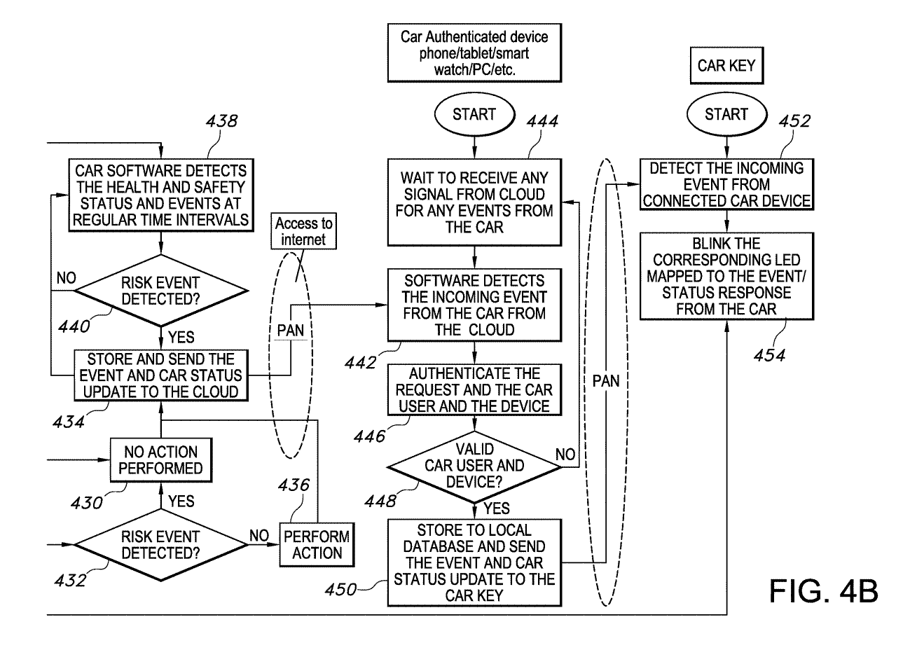

FIGS. 4A and 4B illustrate one embodiment of a vehicle monitoring method of the present invention, including car key 12 detecting that a pushbutton 58 (FIG. 3) has been pressed (step 402). Next, in step 404, car key 12 creates a status request command to be sent to electronic device 16. Car key 12 transmits the command and an identity of car key 12 (step 406). Car key 12 then waits to receive the car status information (step 408).

In step 410, electronic device 16 waits to receive from key 12 a signal for events and commands to transmit to vehicle 14. In step 412, electronic device 16 detects the signal for events and commands from key 12 to transmit to vehicle 14. In steps 414, 416 electronic device 16 authenticates the command and the car user. In step 418, electronic device 16 stores the command in a local database and transmits the command to the cloud.

In step 420, car 14 checks the cloud for any requests from an authenticated electronic device 16. If it is determined by the car in step 422 that no such request is present, then operation returns to step 420. However, if it is determined in step 422 that such request is present, then in step 424 the request, the car user, and electronic device 16 are authenticated. In step 426 it is determined whether the car user and electronic device 16 are valid. If so, then in step 428 an action request is sent to the car controller unit. However, if it is determined in step 426 that the car user and/or electronic device 16 are not valid, then in step 430 no action is performed. After step 428, in step 432 it is determined whether a risk event is detected. If so, then in step 430 no action is performed, and in step 434 the event and car status are stored and updated to the cloud. However, if in step 432 it is determined that no risk event is detected, then in step 436 an action (e.g., the action requested in step 428) is performed, and in step 434 the event and car status are stored and updated to the cloud.

In step 438, software in car 14 detects the health and safety status and events of the car at regular time intervals. In step 440 it is determined whether a risk event is detected by car 14. If not, then operation returns to step 438. However, if it is determined in step 440 that a risk event is detected, then operation proceeds to step 434 and then returns to step 438.

After step 434, in step 442, software in electronic device 16 detects an incoming event from car 14 via the cloud. In step 444, electronic device 16 waits to receive any signal from the cloud for any events from car 14. Operation then proceeds to step 442. After step 442, electronic device 16 authenticates the event, the car user, and the electronic device in step 446. In step 448 it is determined whether the car user and electronic; device are valid. If not, then operation returns to step 444. However, if it is determined in step 448 that the car user and electronic device are valid, then in step 450 the validity of the car user and electronic device is stored, and the event and the car status update are sent to car key 12.

In step 452, car key 12 detects the incoming event from the connected electronic device 16, After either of steps 408 or 452, operation proceeds to step 454, where car key 12 causes its LED corresponding to the event/status response from device 16 to blink.

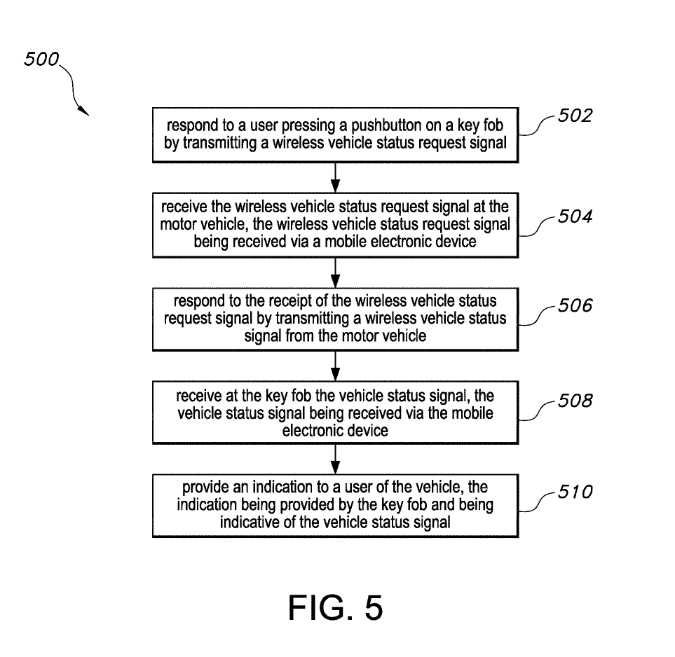

FIG. 5 illustrates one embodiment of a method 500 of the present invention for remotely monitoring a motor vehicle. In a first step 502, a user pressing a pushbutton on a key fob is responded to by transmitting a wireless vehicle status request signal. For example, pushbutton 58 of key fob 12 being pressed (step 402) is detected. In response, in step 404, key fob 12 creates a status request command to be sent to electronic device 16. Key fob 12 may then transmit the command in step 406.

In a next step 504, the wireless vehicle status request signal is received at the motor vehicle via a mobile electronic device. For example, in step 410, electronic device 16 waits to receive from key 12 a signal for events and commands to transmit to vehicle 14. In step 412, electronic device 16 detects the signal for events and commands from key 12 to transmit to vehicle 14.

Next, in step 506, the receipt of the wireless vehicle status request signal is responded to by transmitting a wireless vehicle status signal from the motor vehicle. For example, in step 434 the car status is stored and updated to the cloud from the car.

In step 508, the vehicle status signal is received at the key fob via the mobile electronic device. For example, in step 450 the car status update is sent to key fob 12 from electronic device 16.

In a final step 510, an indication to a user of the vehicle is provided. The indication is provided by the key fob and is indicative of the vehicle status signal. For example, in step 454 key fob 12 causes its LED corresponding to the event/status response from device 16 to blink.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A motor vehicle remote monitoring arrangement, comprising:
a motor vehicle including a wireless communication device configured to transmit a vehicle status signal; and
a vehicle key configured to:
receive the vehicle status signal via a mobile electronic device; and
provide a visible indication to a user of the vehicle, the indication being indicative of the vehicle status signal.

2. The motor vehicle of claim 1 wherein the motor vehicle wirelessly transmits the vehicle status signal in response to receiving a wireless vehicle status request signal.

3. The motor vehicle of claim 2 wherein the wireless vehicle status request signal is transmitted by the vehicle key.

4. The motor vehicle of claim 2 wherein the motor vehicle is configured to authenticate the wireless vehicle status request signal.

5. The motor vehicle of claim 2 wherein the motor vehicle is configured to authenticate the mobile electronic device.

6. The motor vehicle of claim 2 wherein the motor vehicle is configured to authenticate a human user of the motor vehicle.

7. The motor vehicle of claim 1 wherein the vehicle status signal is indicative of a fuel level, a level of battery charging, or a vehicle safety status.

8. A method of remotely monitoring a motor vehicle, the method comprising:
transmitting a vehicle status signal from the motor vehicle;
receiving at the vehicle key the vehicle status signal, the vehicle status signal being received via a mobile electronic device; and
providing on the vehicle key a visual indication to a user of the vehicle, the indication being indicative of the vehicle status signal.

9. The method of claim 8 wherein the motor vehicle wirelessly transmits the vehicle status signal in response to receiving a wireless vehicle status request signal.

10. The method of claim 9 wherein the wireless vehicle status request signal is transmitted by the vehicle key.

11. The method of claim 9 further comprising the motor vehicle authenticating the wireless vehicle status request signal.

12. The method of claim 9 further comprising the motor vehicle authenticating the mobile electronic device.

13. The method of claim 9 further comprising the motor vehicle authenticating a human user of the motor vehicle.

14. The method of claim 8 wherein the vehicle status signal is indicative of a fuel level, a level of battery charging, or a vehicle safety status.

15. A method of remotely monitoring a motor vehicle, the method comprising:
responding to a user pressing a pushbutton on a key fob by transmitting a wireless vehicle status request signal;
receiving the wireless vehicle status request signal at the motor vehicle, the wireless vehicle status request signal being received via a mobile electronic device;
responding to the receipt of the wireless vehicle status request signal by transmitting a wireless vehicle status signal from the motor vehicle;
receiving at the key fob the vehicle status signal, the vehicle status signal being received via the mobile electronic device; and
providing an indication to a user of the vehicle, the indication being provided by the key fob and being indicative of the vehicle status signal.

16. The method of claim 15 further comprising the motor vehicle authenticating the wireless vehicle status request signal.

17. The method of claim 15 further comprising the motor vehicle authenticating the mobile electronic device.

18. The method of claim 15 further comprising the motor vehicle authenticating a human user of the motor vehicle.

19. The method of claim 15 wherein the vehicle status signal is indicative of a fuel level, a level of battery charging, or a vehicle safety status.

20. The method of claim 15 wherein the indication being provided by the key fob comprises a light emitting device on the key fob blinking ON and OFF intermittently.
